(19) United States
(12) Patent Application Publication
(10) Pub. No.: US 2004/0237679 A1
(43) Pub. Date: Dec. 2, 2004

(54) Servo motor with linear output

(76) Inventor: Christopher Milner Enright, Ladera Ranch, CA (US)

Correspondence Address: Chris Enright, 21 Harwick Court, Ladera Ranch, CA, 92694, US

(21) Appl. No.: 10/444,472

(22) Filed: May 27, 2003

(51) Int. Cl. F16H 27/02

(52) U.S. Cl. 74/89.2

(57) ABSTRACT

A mechanical apparatus used to convert a servo motor's rotational motion output into linear motion output is provided.

### FIELD OF THE INVENTION

The present invention relates generally to servo motors. More particularly, the present invention relates to servo motors with linear output.

### BACKGROUND OF THE INVENTION

Servo motors are widely used in the field of motion control in such areas, but not limited to, radio-controlled models, pan tilt units, factory automation, mobile robotics, and walking robots. In particular, servo motors have been employed to manipulate bodies including automobiles, motor boats, airplanes, helicopters, or the like, by controlling their position, speed, or force, among other parameters of motion. In some cases, the servo motors are controlled by wireless means, as is often with models used by hobbyists.

Typically, output from a servo motor is coupled to an arm, sometimes called a “horn”, which rotates about an axis of the servo output shaft. Thus, output from such servo motors is rotational even though common applications require only translational motion in one direction. Attempts have been made to capture rotational motion into a linear actuation using servo horns, but there remains room for improvement.

Accordingly, it is desirable to provide a method and apparatus that provides a servo motor that offers linear output to control motion according to the desired position by the operator.

### SUMMARY OF THE INVENTION

The foregoing needs are met, to some extent, by the present invention, wherein in some embodiments a servo motor is provided that allows translation of rotational motion into linear motion. In accordance with one embodiment of the present invention, a servo motor comprising a spool; and a linkage, wherein the linkage is operably coupled to the spool by a coupling means is provided. In some embodiments, the linkage may be flexible and comprise of plastic, metal, wood, or glass. In other embodiments, the plastic used for the linkage is a thermoplastic. The coupling means may be a hinging means to allow rotation about the spool. In yet other embodiments, the spool, linkage, and coupling means may comprise a single, fixed unit. The linkage may also include a tab portion, positioned perpendicular to the linkage. The spool may comprise a spline designed to operate with the servo motor in some embodiments. Servo motors of the present invention, may also comprise a housing to house the spool. Such housings may include a lid comprising a slot to provide guides for the tab.

In yet other embodiments, a method of translating rotational motion into linear motion is provided, comprising a spool, a linkage; and operably coupling the linkage to the spool by a coupling means. The method may further comprise a tab, wherein the tab is positioned perpendicular to the linkage and spline of the spool is designed to operate with the servo motor. The method may further comprise a housing to house the spool

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a blow-up view from the top illustrating a servo motor according to one embodiment of the invention.

FIG. 2 is a blow-up view from the bottom illustrating a servo motor according to one embodiment of the invention.

FIG. 3 is a detail view of two embodiments of a drum of the invention.

FIG. is an alternative example of linkage coupling means to the spool using a pin.

FIG. 5 is an alternative example of linkage coupling means to the spool using a sprocket.

### DETAILED DESCRIPTION

The invention will now be described with reference to the drawing figures, in which like reference numerals refer to like parts throughout. An embodiment in accordance with the present invention provides a servo motor with linear output, by employing a drum with a linkage to convert the rotational motion directly into linear motion. The drum is positioned in a customized housing designed to fit servo motors. This apparatus additionally provides the user with a method of linearizing the output from a standard servo with rotational output.

Servo motors of the instant invention may be designed for retrofitting onto servo motors available in the art. Therefore, what follows is a description of one embodiment of a servo of the instant invention. It will be apparent to one of ordinary skill in the art from the teachings herein that modifications in some or all of the parameters described below may be required depending on the particular servo, but that all such modifications fall within the scope and spirit of the invention.

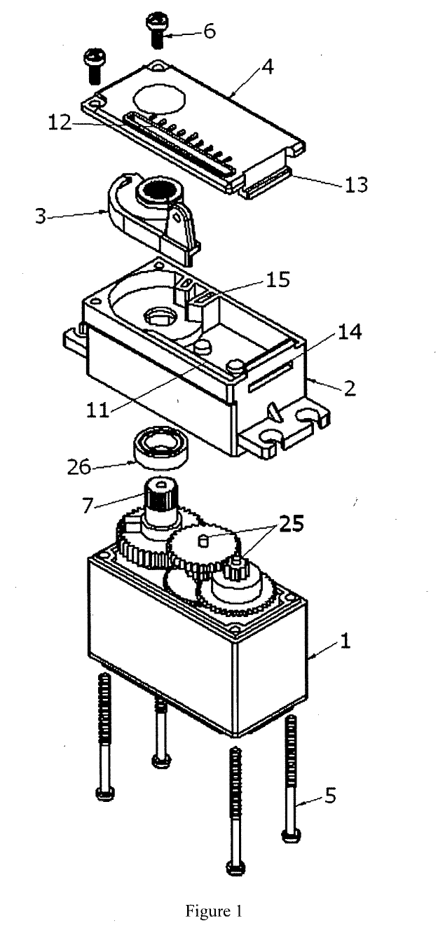

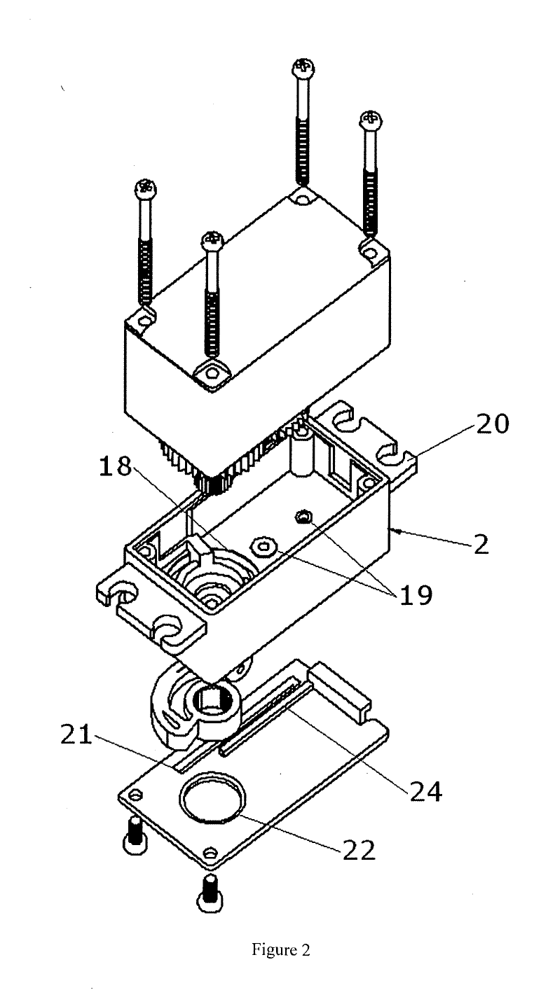

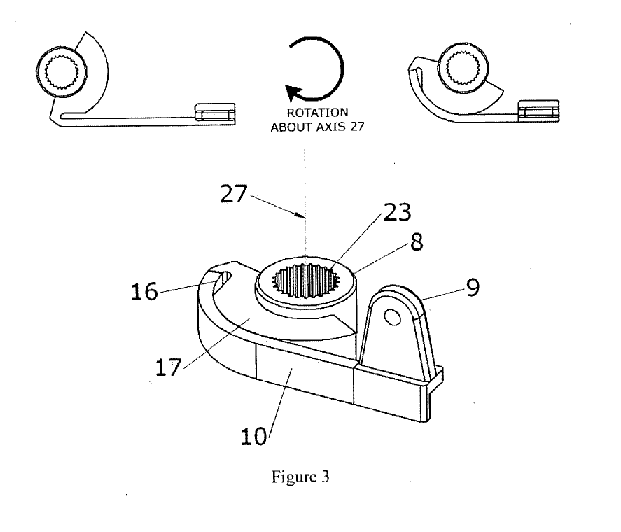

In one embodiment, FIG. 1 shows a servo motor 1 with output shaft 7 that is used to transmit direction to another body. The linear servo housing 2 is screwed to the servo motor housing 1 with the servo motor screws 5. The housing 2 is designed to accommodate the servo motor 1 as follows. The gear train shafts 25 arising from the servo motor within servo motor housing 1 project into the gear train blind holes 19 incorporated in the linear servo housing 2 as best illustrated in FIG. 2. As is also shown, housing 2 is molded with indentation 18 to fit the bearing 26 encompassing output shaft 7. Bearing 26 can be a ball bearing or a bushing type design. Referring back to FIG. 1, output shaft 7 is operably connected to the drum spline 23 to transfer generated torque to the drum 3. As will be evident from the teachings herein, the drum spline 23 can be modified to accommodate a different output shaft from a different servo motor. The drum pilot bearing locator 8 is inserted into the top pilot locator hole 22 in the housing top 4. The housing top 4 is fastened to the linear servo housing 2 using the top screws 6. For additional restraint, the top 4 and the servo housing 2 and may be optionally designed with top retainer clip 13 and housing clip receptacle 14, respectively.

The output shaft 7 transmits the torque generated by the servo motor 1 to the drum 3 through the drum spline 23. The torque rotates the drum spool 17 back and forth in the direction of output shaft 7 rotation. The rotation about output shaft 7 includes an angle of about 60° to about 150°. In other embodiments the angle may range from about 60° to 120°. When the drum spool 17 is rotated, the linkage 10 between the drum spool 17 and the drum tab 9 is coiled and uncoiled on the drum spool 17. Linkage 10 may comprise any resilient material, including, but not limited to, plastic, metal, or rubber, to allow for bending of linkage 10 around drum spool 17. As this occurs, the drum tab 9 traverses back and forth within housing guide 11 which is designed into housing 2 and top guide 24 and top guide slot 21 which are designed into top 4. The guides 11, 24 and guide slot 21 function as restraints which permit the drum tab 9 to traverse back and forth tangent to the drum spool 17 and substantially parallel to the manipulated body's desired direction of motion. During operation, the graduated position scale 12 visually shows the position the drum tab 9 is in relative to the servo motor output shaft 7 rotational center position. The drum stops 15 block the drum 3 from rotating beyond the desired limits of rotation and binding the linkage 10. The linear servo assembly can be mounted via the mounting ears 20 in any application.

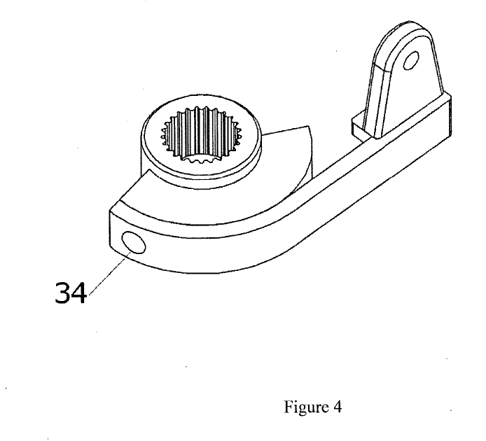

FIG. 3 shows two embodiments of the drums of the present invention. In FIG. 3, drum 3 is depicted as a single entity. In other words, linkage 10 is molded directly to drum spool 17 through connection 16. Connection 16 may be designed with flexible materials, such as plastic, to allow sufficient pliability to partially relieve the fatigue stress on the connection created by the cyclic motion. In other embodiments, as shown in FIG. 4, the connection 34 between linkage 10 and drum spool 17 may be a pin mechanism. It will be appreciated by those of ordinary skill in the art from the teachings herein, that other flexible or rotational connections may be used to provide a flexible connection as desired.

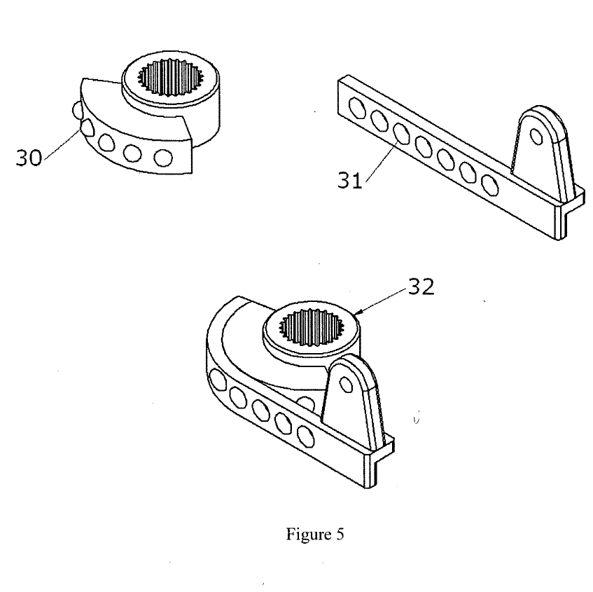

FIG. 5 shows another embodiment of the instant invention, wherein the drum is composed of two pieces, the linkage 31 and the sprocket drive spool 30. The sprocket drive spool 30 can transfer the rotational motion to the chain like linkage 31 when assembled into the drum 32. The gear and sprocket type design as shown is but one embodiment of other means to transfer rotational motion from the spools 17, 30 to the linkages 10, 31.

Without being bound by or limited to theory, generally, the servos of the present invention use a drum to coil and uncoil the linkage at a fixed radius to achieve linearity. The drum tab is confined in 2 of the 3 translational degrees of freedom and all 3 rotational degrees of freedom. This allows traverse movement in one translational degree of freedom that is tangent to the outer radius of the drum spool.

The drum 3 may be manufactured with materials known in the art, including plastics. In some embodiments, a co-polymeric polypropylene thermoplastic, such as Huntsman P5M5K-047, may be used. Desirable plastics can have high tensile strength and fatigue resistance properties. High tensile strength may be greater than about 4000 psi tested to over 1,000,000 cycles. In some embodiments, the housing 1 may be manufactured using a high grade engineered resin such as Polycarbonate ABS blend, Cycoloy CI000HF.

The many features and advantages of the invention are apparent from the detailed specification, and thus, it is intended by the appended claims to cover all such features and advantages of the invention, which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A servo motor, comprising:
(a) a spool; and
(b) a linkage, wherein the linkage is operably coupled to the spool by a coupling means.

2. The servo motor of claim 1, wherein the linkage is flexible.

3. The servo motor of claim 1, wherein the linkage is comprised of plastic, metal, wood, or glass.

4. The servo motor of claim 3, wherein the linkage is comprised of a thermoplastic.

5. The servo motor of claim 1, wherein the coupling means is flexible.

6. The servo motor of claim 1, wherein the coupling means is a hinging means to allow rotation about the spool.

7. The servo motor of claim 1, wherein the spool, coupling means, and linkage comprise a single, fixed unit.

8. The servo motor of claim 1, further comprising a tab, wherein the tab is positioned perpendicular to the linkage.

9. The servo motor of claim 1, wherein the spool comprises a spline, the spline designed to operate with the servo motor.

10. The servo motor of claim 1, further comprising a housing to house the spool, the housing having a lid.

11. The servo motor of claim 10, wherein the lid comprises a slot to provide guides for the tab.

12. The servo motor of claim 11, wherein the lid is marked along the slot to indicate relative movement of the tab.

13. A method of translating rotational motion into linear motion, comprising:
(a) providing a spool;
(b) a linkage; and
(c) operably coupling the linkage to the spool by a coupling means.

14. The method of claim 13, further comprising a tab, wherein the tab is positioned perpendicular to the linkage.

15. The method of claim 13, wherein the spool comprises a spline, the spline designed to operate with the servo motor.

16. The method of claim 13, further comprising a housing to house the spool, the housing having a lid.

17. The method of claim 16, wherein the lid comprises a slot to provide guides for the tab.

18. The method of claim 17, wherein the lid is marked along the slot to indicate relative movement of the tab.
